(19) United States
(12) Patent Application Publication
(10) Pub. No.: US 2009/0290237 A1
(43) Pub. Date: Nov. 26, 2009

(54) LENS ASSEMBLY AND LENS MODULE INCORPORATING THE SAME

(75) Inventor: TSAI-SHIH TUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/327,586

(22) Filed: Dec. 3, 2008

(30) Foreign Application Priority Data
May 26, 2008 (CN) 200810301765.3

(51) Int. Cl. G02B 11/02

(52) U.S. Cl. 359/796

(57) ABSTRACT

An exemplary lens assembly comprises a first lens and a second lens. The first lens includes a first central portion, a first peripheral portion surrounding the first central portion and a stepped portion. The stepped portion has a first step upwardly extending from the first peripheral portion and a second step upwardly extending from the first step. The first step has an inner side surface, an outer side surface, and a top surface. The second step has a side surface adjoining the top surface. The second lens includes a second central portion, a second peripheral portion surrounding the second central portion and a protrusion extending downwardly from the second peripheral portion. The protrusion has an engaging surface and a bottom surface adjoining the engaging surfaces. The protrusion is engaged with the stepped portion in a manner that the bottom surface is in contact with the top surface.

### CROSS-REFERENCE TO RELATED APPLICATIONS

This application is related to commonly-assigned copending applications Ser. No. 12/061893, entitled “Lens with Collar and Lens Module Using same”, Ser. No. 12/168785, entitled “Lens Module and Optical Module Incorporating the same”, Ser. No. 12/248287, entitled “Optical Lens Assembly and Lens Module” Incorporating the same”, and Ser. No. 12/247402, entitled “Optical Lens Group and Related Lens Module”. Disclosures of the above-identified applications are incorporated herein by reference.

### BACKGROUND

1. Technical Field

The present disclosure relates to optical imaging devices and, particularly, to a lens assembly and a lens module incorporating the same.

2. Description of Related Art

Currently, with the development of electronic devices with multiple functions, image pick-up apparatuses have become widely used in a variety of consumer electronic devices, such as notebook computers, personal digital assistants (PDAs), cellphones, etc. In the meantime, demand for improving image quality is increasing, which is essentially dependent on the imaging quality of a lens module in the image pick-up apparatus. That is, a lens module with high image quality is desired.

Referring to FIG. 5, an optical lens assembly includes two lenses 41, 42. The lenses 41 and 42 each has a central portion and a radially extending portion surrounding the central portion. The radially extending portion of the lens 41 includes a first protrusion 411 extending outwardly, and a first surface 412 adjoining the first protrusion 411. The radially extending portion of the lens 42 includes a second protrusion 421 extending outwardly and engaged with the first protrusion 411. The second protrusion 421 has a second surface 422. When assembling the two lenses 41 and 42 together, the first and second surfaces 412 and 422 contact each other. The second protrusion 421 can act as a spacer, for example, a distance between the central portions of the lenses 41, 42 can be adjusted by adjusting the height of the second protrusion.

To increase the distance between the lenses 41 and 42, it is necessary to increase the height of the second protrusion. However, a rise in the height of the second protrusion 421 also increases manufacturing difficulty thereof and dimension tolerance of the second protrusion 421 may exceed an acceptable range. As a result, the second protrusion 421 will fail to match with the lens 42. Furthermore, misalignment of optical axes of the lenses 41 and 42 will occur. Consequently, such a lens module having the above optical lens assembly above may provide distorted images.

Therefore, a new lens assembly is desired to overcome the above mentioned problems.

### SUMMARY

An exemplary lens assembly comprises a first lens and a second lens. The first lens includes a first central portion, a first peripheral portion surrounding the first central portion and a stepped portion. The stepped portion has a first step upwardly extending from the first peripheral portion and a second step upwardly extending from the first step. The first step has an inner side surface, an outer side surface, and a top surface. The second step has a side surface adjoining the top surface of the first step. The second lens includes a second central portion, a second peripheral portion surrounding the second central portion and a protrusion extending downwardly from the second peripheral portion. The protrusion has an engaging surface and a bottom surface adjoining the engaging surfaces. The protrusion is engaged with the stepped portion in a manner that the bottom surface is in contact with the top surface of the first step.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of a lens assembly according to a first embodiment.

FIG. 2 is an enlarged view of an area II in FIG. 1.

FIG. 3 is a partial cross-sectional view of a lens assembly according to a second embodiment.

FIG. 4 is a schematic, cross-sectional view of a lens module according to an exemplary embodiment.

FIG. 5 is a schematic, cross-sectional view of a typical optical lens assembly.

### DETAILED DESCRIPTION OF THE EMBODIMENTS

Reference will now be made to the drawings to describe exemplary embodiments of the present lens assembly in detail.

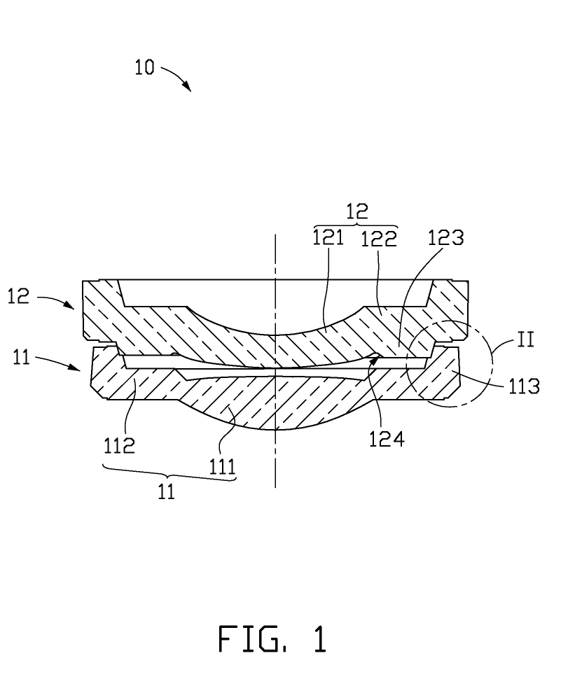

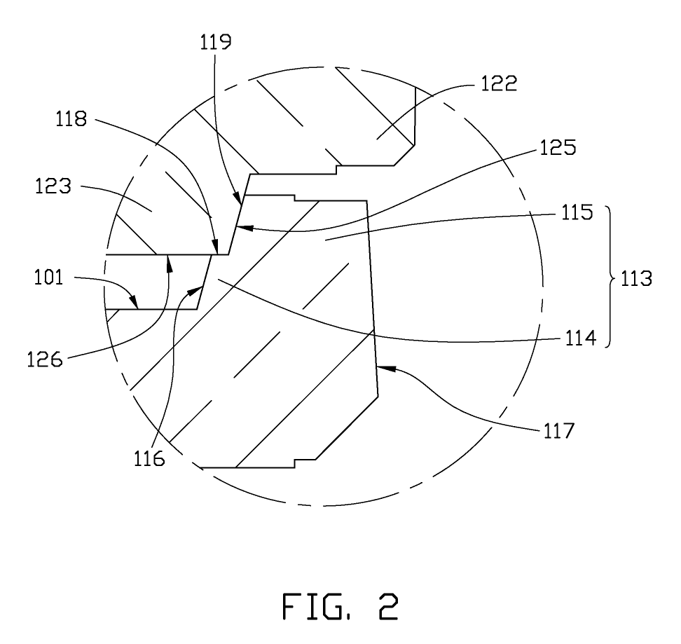

Referring to FIG. 1 and FIG. 2, a lens assembly 10 according to a first embodiment includes a first lens 11 and a second lens 12. The first and second lens 11 and 12 can be made of plastic, glass or other optical materials.

The first lens 11 includes a first central portion 111, a first peripheral portion 112 surrounding the first central portion 111, and a stepped portion 113. The first central portion 111 is configured for cooperating with other optical elements to capture images. The first peripheral portion 112 has a surface 101 facing the second lens 12. The surface 101 adjoins between the stepped portion 113 and the first central portion 111. The stepped portion 113 has a first step 114 and a second step 115. The first step 114 upwardly extends from the first peripheral portion 112, and the second step 115 upwardly extends from the first step 114. The first step 114 has an inner side surface 116, an outer side surface 117, and a top surface 118. The second step 115 has a side surface 119 adjoining the top surface 118. This is, the second step 115 extends outwardly from the top surface 118 toward the second lens 12.

In the present embodiment, the first and second steps 114 and 115 are annular steps surrounding the first central portion 111, and gradually become narrower from the first peripheral portion 112 to end of the stepped portion 113. In other word, the inner side surface 116 and the side surface 119 are outwardly slanted inner surfaces of the stepped portion 113 respectively. The inner side surface 116 adjoins the surface 101. The top surface 118 is perpendicular to an optical axis of the first central portion 111, and adjoins the inner side surface 116 and the side surface 119. Compared with the second step 115, the first step 114 is closer to the first central portion 111.

The second lens 12 includes a second central portion 121 a second peripheral portion 122 surrounding the second central portion 121, and a protrusion 123 extending from the second peripheral portion 122. The second central portion 121 is configured for cooperating with other elements (e.g. the first central portion 111 of the first lens 11) to capture images. The protrusion 123 has a lateral surface 124, an engaging surface 125, and a bottom surface 126 adjoining the lateral surface 124 and the engaging surface 125.

The protrusion 123 is an annular protrusion surrounding the second central portion 121. The engaging surface 125 are inwardly slanted outer surface of the protrusion 123, and has a slanted degree corresponding to the slanted degree of the first step 114. This is, the inner side surface 116 and the side surface 119 have the same slanted degree to that of the engaging surface 125. The bottom surface 126 is perpendicular to a central axis of the second central portion 121.

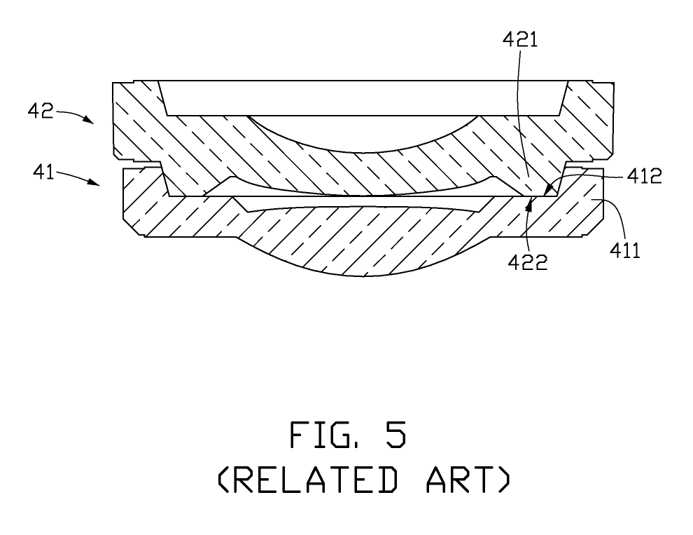

The protrusion 123 is engaged with the stepped portion 113, and the bottom surface 126 is in contact with the top surface 118, and the engaging surface 125 is in contact with the side surface 119. By contacting the bottom surface 126 with the top surface 118, a distance between the first lens 11 and the second lens 12 is maintained at a predetermined level according to height of the second protrusion 123 and the first step 114. If the top surface 118 is coplanar with the surface 101, i.e. the first surface 412 (shown in FIG. 5), the protrusion 123 should be in contact with the surface 101 for achieving a special distance between the first and second lenses 11 and 12. Nevertheless, in the present embodiment, the top surface 118 of the first step 113 is closer to the protrusion 123 than the surface 101, the protrusion 123 is only in contact with the top surface 118 to achieve the same distance. Thus, the height of the protrusion 123 can be decreased due to the first step 113 already properly being supported the second protrusion 123 above the surface 101. The structure of the present lens assembly 10 is beneficial to achieving an easier manufacturing process and a higher manufacturing precision.

To increase a stability of the lens assembly 10, an area of the bottom surface 126 is larger than that of the top surface 118 thereby enabling total region of the top surface 118 is covered by the bottom surface 126.

The side surface 119 and the top surface 118 is at an first angle (not labeled) with each other, and the engaging surface 125 and the bottom surface 126 is at an second angle (not labeled) with each other. For ensuring the first and second lenses 11 and 12 are securely fixed together, the first and second angles should be the same.

In an assembling process, the engaging surface 125 is guided by the side surface 119. When the bottom surface 126 is in contact with the top surface 118, the stepped portion 113 engages with the protrusion 123 for fixing the first lens 11 to the second lens 12. The outer side surface 117 is spaced apart from the second lens 12. The second step 115 of the first lens 11 is spaced apart from the second peripheral portion 122 of the second lens 12. As detailed in the previous description, the lenses allow easier and more precise manufacturing, while contact between the surfaces of the lenses assures accurate positioning. Furthermore, the axes of the lenses 11 and 12 will be coincident. Thus, a lens module having the lens assembly 10 will be easy and convenient to accurately assemble and provide better image quality.

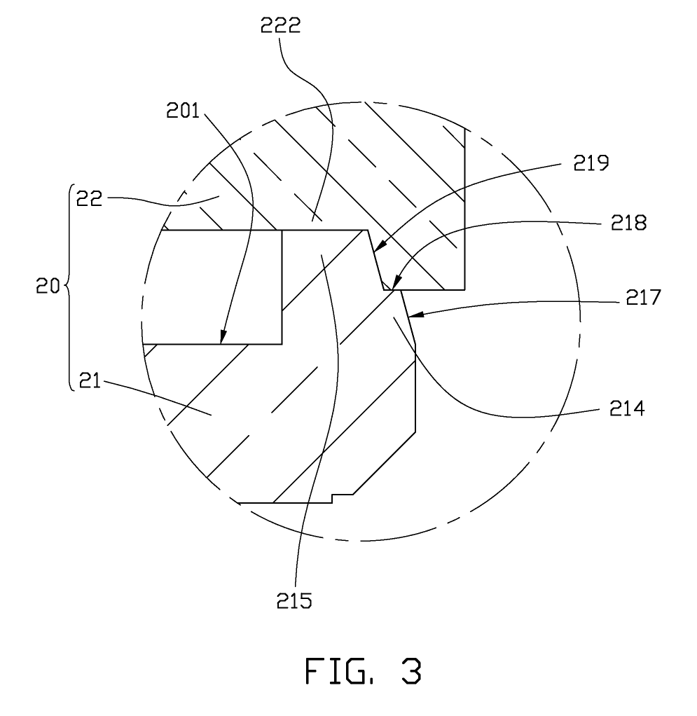

Referring to FIG. 3, a lens assembly 20 of the second embodiment is shown. A structure of the lens assembly 20 is similar to that of the lens assembly 10 of the first embodiment, except the stepped portion 213. The second step 215 of the first lens 21 adjoins the surface 201. The top surface 218 adjoins the outer side surface 217 of the first step 214. The outer side surface 217 and the side surface 219 of the first step 214 are inwardly slanted outer surfaces of the stepped portion (not labeled) respectively. In assembly, the second step 215 contacts the second peripheral portion 222 of the second lens 22.

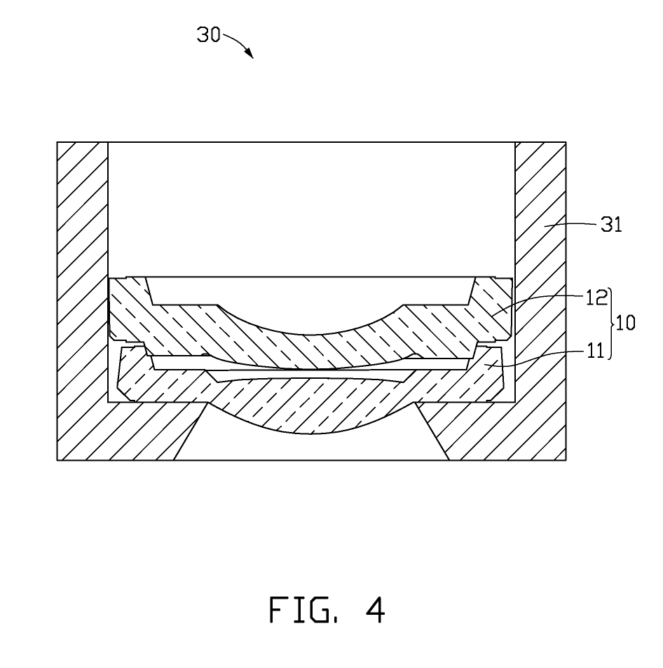

Referring to FIG. 4, a lens module 30 of an exemplary embodiment of an environment utilizing the lens assembly 10 of the first embodiment is shown. The lens module 30 includes a barrel 31. The barrel 31 receives the lens assembly 10 therein.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A lens assembly comprising:
a first lens comprising a first central portion, a first peripheral portion surrounding the first central portion and a stepped portion, the stepped portion having a first step upwardly extending from the first peripheral portion and a second step upwardly extending from the first step, the first step having an inner side surface, an outer side surface, and a top surface, the second step having a side surface adjoining the top surface of the first step; and
a second lens comprising a second central portion, a second peripheral portion surrounding the second central portion and a protrusion extending downwardly from the second peripheral portion, the protrusion having an engaging surface and a bottom surface adjoining the engaging surfaces, the protrusion being engaged with the stepped portion in a manner that the bottom surface is in contact with the top surface of the first step.

2. The lens assembly as claimed in claim 1, wherein the stepped portion of the first central portion is annular.

3. The lens assembly as claimed in claim 1, wherein the protrusion of the second lens is annular.

4. The lens assembly as claimed in claim 1, wherein the top surface adjoins the inner side surface of the first step.

5. The lens assembly as claimed in claim 1, wherein the top surface adjoins the outer side surface of the first step.

6. The lens assembly as claimed in claim 1, wherein the second step is spaced apart from the second peripheral portion of the second lens.

7. The lens assembly as claimed in claim 1, wherein the inner side surface of the first step and the side surface of the second step are outwardly slanted inner surfaces of the stepped portion.

8. The lens assembly as claimed in claim 1, wherein the outer side surface of the first step and the side surface of the second step are inwardly slanted outer surfaces of the stepped portion.

9. The lens assembly as claimed in claim 1, wherein the engaging surface is in contact with the side surface of the second step.

10. The lens assembly as claimed in claim 1, wherein an area of the bottom surface is larger than that of the top surface thereby enabling total region of the top surface to be covered by the bottom surface.

11. A lens module comprising:
a first lens comprising a first central portion, a first peripheral portion surrounding the first central portion and a stepped portion, the stepped portion having a first step upwardly extending from the first peripheral portion and a second step upwardly extending from the first step, the first step having an inner side surface, an outer side surface, and a top surface, the second step having a side surface adjoining the top surface of the first step;
a second lens engaged with the first lens, the second lens comprising a second central portion, a second peripheral portion surrounding the second central portion and a protrusion extending downwardly from the second peripheral portion, the protrusion having an engaging surface and a bottom surface adjoining the engaging surfaces, the protrusion being engaged with the stepped portion in a manner that the bottom surface is in contact with the top surface of the first lens; and
a barrel receiving the first lens and the second lens therein.

12. The lens module as claimed in claim 11, wherein the stepped portion of the first central portion is annular.

13. The lens module as claimed in claim 11, wherein the protrusion of the second lens is annular.

14. The lens module as claimed in claim 11, wherein the top surface adjoins the inner side surface of the first step.

15. The lens module as claimed in claim 11, wherein the top surface adjoins the outer side surface of the first step.

16. The lens module as claimed in claim 11, wherein the second step is spaced apart from the second peripheral portion of the second lens.

17. The lens assembly as claimed in claim 11, wherein the inner side surface of the first step and the side surface of the second step are outwardly slanted inner surfaces of the stepped portion.

18. The lens module as claimed in claim 11, wherein the outer side surface of the first step and the side surface of the second step are inwardly slanted outer surfaces of the stepped portion.

19. The lens module as claimed in claim 11, wherein the engaging surface is in contact with the side surface of the second step.

20. The lens module as claimed in claim 11, wherein an area of the bottom surface is larger than that of the top surface thereby enabling total region of the top surface to be covered by the bottom surface.
